(19) United States
(12) Patent Application Publication
(10) Pub. No.: US 2006/0130278 A1
(43) Pub. Date: Jun. 22, 2006

(54) Hinge device with locking function

(75) Inventors: Yen Yu Chen, Taipei (TW); Ying-Shan Hung, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/283,748

(22) Filed: Nov. 22, 2005

(30) Foreign Application Priority Data
Dec. 21, 2004 (TW) 093139903

(51) Int. Cl. E05D 11/08

(52) U.S. Cl. 16/342

(57) ABSTRACT

A hinge device with a locking function includes a first locking element, a first connecting element, a second locking element and a connecting shaft. The first locking element has a first through hole and a first locking portion. The first connecting element has a second through hole. The first connecting element is connected with the first locking element. The second locking element is disposed between the first through hole and the second through hole. The second locking element has a shaft hole and a second locking portion corresponding to the first locking portion. The connecting shaft passes through the first through hole, the shaft hole and the second through hole so as to form the hinge device.

### BACKGROUND OF THE INVENTION

1. Field of Invention

The invention relates to a hinge device with a locking function, and more particularly to a latch-free hinge device with a locking function.

2. Related Art

Popular electrical products are designed to be foldable, and the foldable products have become one of the current trends.

For example, a portable computer includes a monitor and a main body hinged to the monitor using a hinge structure, such that the monitor and the main body may be opened and closed according to the using status.

In general, when the portable computer is not used and the monitor hinged to the main body is to be closed by way of, for example, locking, it is often needed to install a latch structure in the monitor and the main body to close the portable computer.

Recently, the manufacturers have developed a latch-free hinge device capable of locking the monitor with the main body. As shown in FIG. 1 which illustrates a portable computer as an example, a cam structure in a hinge connecting a monitor 11 with a main body 12 enables the portable computer to be closed. The cam structure includes a first cam element 13 and a second cam element 14. Two recesses 131 are formed at two sides of a center of a surface of the first cam element 13. Two projections 141 corresponding to the recesses 131 are formed on the surface of the second cam element 14. When the monitor 11 and the main body 12 are closed, the two projections 141 are respectively located in the two recesses 131 to lock the monitor 11 and the main body 12.

However, when the user opens the portable computer, especially when the portable computer is designed such that the monitor can be opened to the position of 180 degrees with respect to the main body, the projections 141 will fall into the recesses 131 in the above-mentioned portable computer of FIG. 1. At the moment when the projections fall into the recesses, an inertial force causes the monitor to rotate slightly. At this time, if the portable computer is placed on a table, the monitor tends to collide with the table and may thus be damaged. In addition, no frictional contact exists between the projection 141 and the recess 131 but the frictional contact continuously exists between the projection 141 and the surface of the first cam element 13. So, the locking status of the projection and the recess tends to deteriorate due to the wear of the projection 141, the torsional force of the hinge tends to decrease, the hinge tends to loose in usage, and the lifetime of the hinge is shortened accordingly.

Therefore, it is an important subject to prevent the cam structure of the hinge from colliding with the contact surface of the monitor when the hinge is rotated 180 degrees, to decrease the frequency of frictional contacts of the latch-free hinge device having the cam structure, and thus to lengthen the lifetime of the hinge device.

### SUMMARY OF THE INVENTION

In view of the foregoing, the invention is to provide a hinge device with a locking function having a lengthened lifetime.

To achieve the above, a hinge device with a locking function of the invention includes a first connecting element, a first locking element, a second locking element and a connecting shaft. The first connecting element has a first through hole. The first locking element has a second through hole and a first locking portion. The first locking element is connected with the first connecting element. The second locking element is disposed between the first through hole and the second through hole. The second locking element has a shaft hole and a second locking portion corresponding to the first locking portion. The connecting shaft passes through the first through hole, the shaft hole and the second through hole.

In addition, the embodiment of the invention also discloses a hinge device with a locking function, which includes a first locking element, a second locking element and a connecting shaft. The first locking element has a first through hole and a slot, and the second locking element has a strip-like projection corresponding to the slot. The second locking element has a shaft hole such that the first locking element is locked with the second locking element. The connecting shaft passes through the first through hole and the shaft hole such that the first locking element and the second locking element may be pivotally rotated.

As mentioned hereinabove, the hinge device with the locking function according to the invention utilizes the first locking element and the second locking element to replace the conventional latch structure and achieve the locking effect. In addition, no frictional contact exists between the first and second locking portions after the second locking portion has parted from the corresponding first locking portion. So, the lifetime of the hinge device may be lengthened.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing the conventional hinge device;

FIG. 2 is an exploded view showing a hinge device with a locking function according to a preferred embodiment of the invention;

FIG. 3 is a partially exploded view showing the hinge device according to the preferred embodiment of the invention;

FIG. 4 is a cross-sectional view taken along a line A-A of FIG. 3; and

FIGS. 5A and 5B are schematic illustrations showing opened states of the hinge device according to the preferred embodiment of the invention.

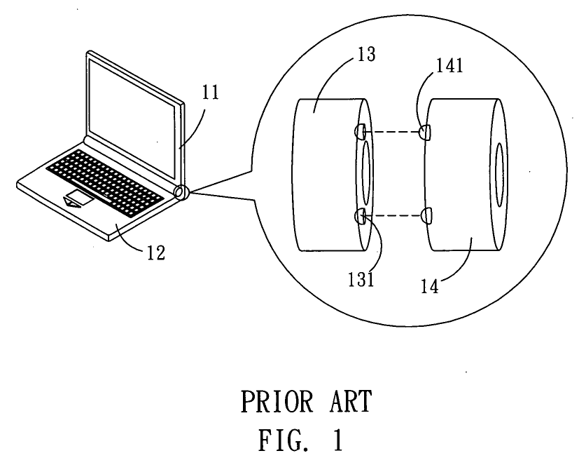

### DETAILED DESCRIPTION OF THE INVENTION

The present invention will be apparent from the following detailed description, which proceeds with reference to the accompanying drawings, wherein the same references relate to the same elements.

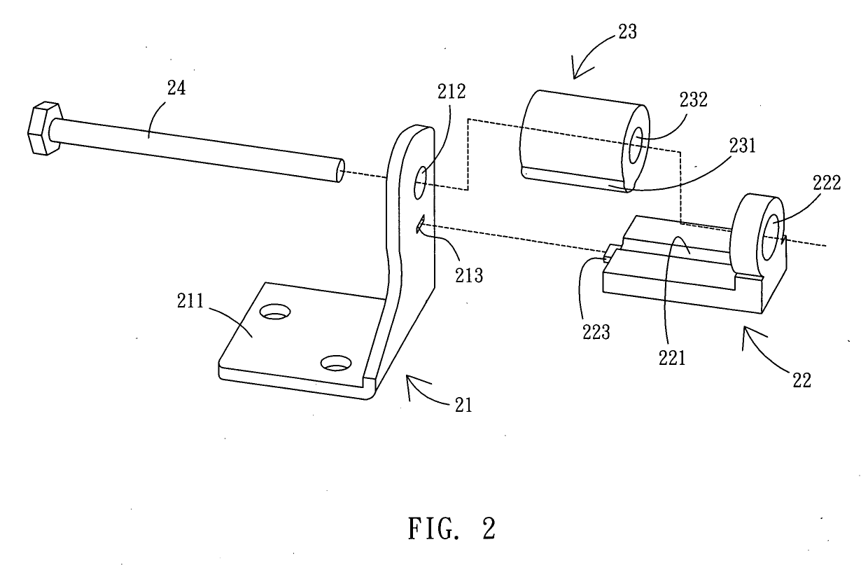

Referring to FIG. 2, a hinge device with a locking function according to a preferred embodiment of the invention includes a first connecting element 21, a first locking element 22, a second locking element 23 and a connecting shaft 24.

The first locking element 22 has a first locking portion 221 and a first through hole 222. In this embodiment, the first locking portion 221 is a slot. In addition, the first locking element 22 further includes a first combining portion 223.

The first connecting element 21 has a second through hole 212 and the first connecting element 21 is connected with the first locking element 22. In this embodiment, the first connecting element 21 further includes a first connection portion 211 and a second combining portion 213. The first connection portion 211 is to be connected with a first electrical device, which is a portable computer host in this embodiment. Of course, the first connection portion 211 may also be connected with a main body or a monitor of a foldable mobile phone, for example. In addition, the second combining portion 213 is to be connected with the first combining portion 223 of the first locking element 22.

The second locking element 23, which is disposed between the second through hole 212 and the first through hole 222, has a shaft hole 232 and a second locking portion 231 corresponding to the first locking portion 221. For example, the first locking portion 221 is a concave portion and the second locking portion 231 is a convex portion. In this embodiment, the second locking element 23 is a cylinder, and the second locking portion 231 is disposed on a side surface of the cylinder. The second locking portion 231 may be a strip-like projection to be locked with the first locking portion 221.

The connecting shaft 24 sequentially passes through the second through hole 212, the shaft hole 232 and the first through hole 222.

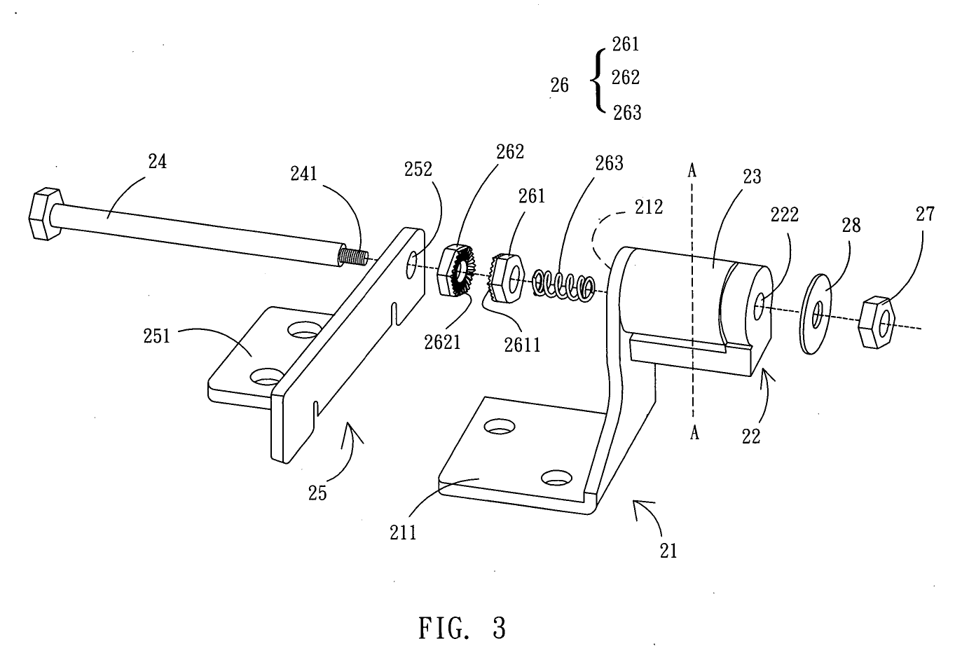

Referring to FIG. 3, the hinge device with the locking function according to the preferred embodiment of the invention may further include a second connecting element 25, a hinge member 26 and a fixing member 27.

The second connecting element 25 is made of, for example, the material of zinc alloy, and the second connecting element 25 has a second connection portion 251 and a third through hole 252. The second connection portion 251 is to be connected with a second electrical device. In this embodiment, the second connection portion 251 is connected with a monitor of a portable computer. Of course, the portion 251 may also be connected with a main body or a monitor of a foldable mobile phone.

The hinge member 26 is disposed between the second through hole 212 of the first connecting element 21, which is opposite to the second locking element 23, and the third through hole 252 of the second connecting element 25. In this embodiment, the hinge member 26 may be a disk-like elastic hinge member capable of providing the torsional force required when the hinge is rotated.

In this embodiment, the hinge member 26 may further include a first frictional element 261, a second frictional element 262 and a springiness member 263. The first frictional element 261 has a first frictional surface 2611 and the second frictional element 262 has a second frictional surface 2621 in contact with the first frictional surface 2611. The springiness member 263 is, for example, a spring, which may be disposed between the first frictional element 261 and the second through hole 212 or between the second frictional element 262 and the third through hole 252 in order to provide the frictional force (or torsional force) when the hinge device is pivotally rotated.

Herein, the connecting shaft 24 sequentially passes through the third through hole 252, the hinge member 26, the second through hole 212, the shaft hole 232 and the first through hole 222, and then the fixing member 27 is used to fix the connecting shaft 24. In this embodiment, the connecting shaft 24 may be a screw having one end formed with a plurality of threads 241, and the fixing member 27 may be a nut to be screwed to the screw.

In this embodiment, in order to combine the connecting shaft 24 with the fixing member 27 firmer, a washer 28, which may be made of the plastic or metallic material, may be further disposed between the first through hole 222 and the fixing member 27.

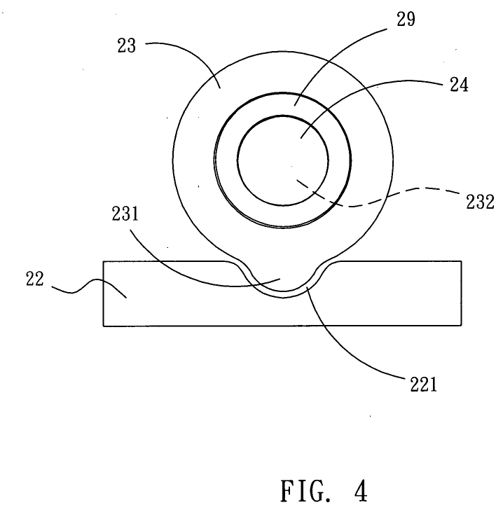

FIG. 4 is a cross-sectional view taken along a line A-A of FIG. 3 to show the hinge device. In order to prevent the second locking element 23 from been irreversibly locked during the pivotal rotation, a buffer element 29 made of any suitable material may further be disposed between the shaft hole 232 of the second locking element 23 and the connecting shaft 24.

FIG. 4 shows an example of the portable computer in the embodiment when the monitor of the portable computer and the host are closed, wherein the first connection portion 211 is connected with the portable computer host and the second connection portion 251 is connected with the monitor of the portable computer. At this time, the second locking portion 231 of the second locking element 23, which is a strip-like projection, for example, is located in the first locking portion 221 of the first locking element 22, which is a slot for example. Thus, a locking force may be provided to lock the monitor with the host of the portable computer without the need of an additional latch structure to lock the monitor with the main body.

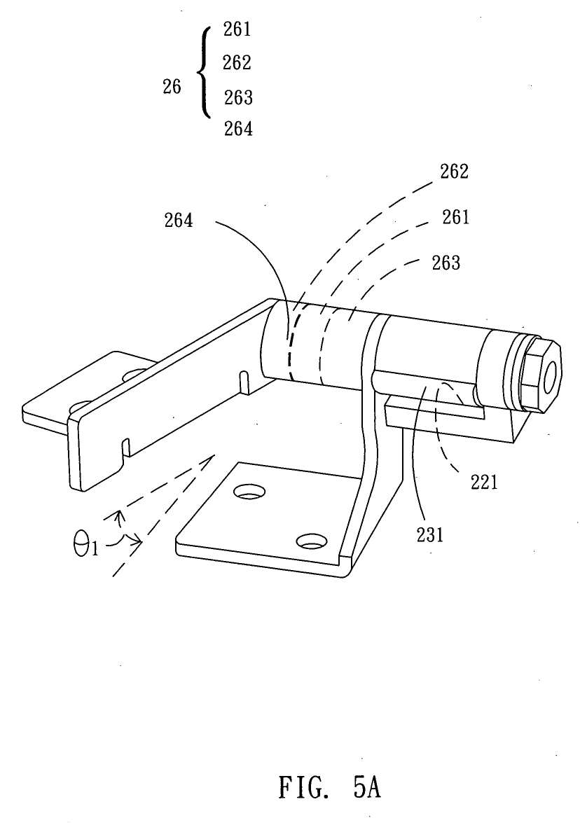

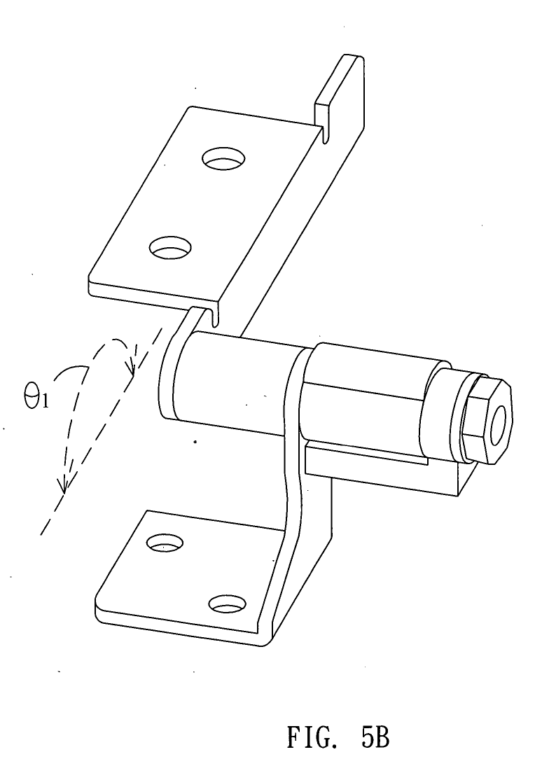

As shown in FIG. 5A, a covering element 264 of the hinge member 26 further may be utilized to cover the first frictional element 261, the second frictional element 262 and the springiness member 263 in order to glorify the appearance and possibly prevent the hinge member 26 from being damaged by external forces. The angle between the monitor and the main body is θ₁. When the monitor is opened, the second locking element 23 can be pivotally rotated through the hinge member 26. When the opening force is larger than the locking force, the monitor may be opened. After the monitor is opened (θ₁ is larger than about 15 degrees in this embodiment), the second locking portion 231 parts from the first locking portion 221 and will be no longer worn. That is, the second locking portion 231 is in frictional contact with the first locking portion 221 only when θ₁ ranges from 0 to 15 degrees. However, the angle can be modified by the designer according to the product requirement. After θ₁ exceeds 15 degrees, the frictional force (or torsional force) for supporting the monitor is still provided by the hinge member 26.

As shown in FIG. 5B, when θ₁ is 180 degrees, it is possible to avoid the condition that the monitor collides with the table or the contact surface due to the inertial force in the prior art because the second locking portion 231 is still in the opened state.

In summary, the hinge device with the locking function according to the invention utilizes the first locking element and the second locking element to replace the conventional latch structure and to achieve the object of locking. Compared to the prior art, the frictional contact between the first and second locking portions occurs only when the second locking portion is parting from the first locking portion in the hinge device with the locking function according to the invention. That is, no frictional contact occurs after the second locking portion has parted from the first locking portion. Therefore, when the user is using the product, his or her switching operation cannot make the serious wear of the locking portions owing to the frequently frictional contacts, and the lifetime can be lengthened.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A hinge device with a locking function, comprising:
a first locking element having a first through hole and a first locking portion;
a first connecting element having a second through hole and connected with the first locking element;
a second locking element disposed between the first through hole and the second through hole and having a shaft hole and a second locking portion locked with the first locking portion; and
a connecting shaft passing through the first through hole, the shaft hole and the second through hole.

2. The hinge device according to claim 1, further comprising:
a second connecting element having a third through hole; and
a hinge member disposed between the second through hole of the first connecting element and the third through hole of the second connecting element, wherein the connecting shaft passes through the third through hole, the hinge member, the second through hole, the shaft hole and the first through hole.

3. The hinge device according to claim 2, wherein the hinge member comprises:
a first frictional element having a first frictional surface;
a second frictional element having a second frictional surface contacting the first frictional surface to provide a frictional force; and
a springiness member disposed between the first frictional element and the second through hole.

4. The hinge device according to claim 3, wherein the springiness member is disposed between the second frictional element and the third through hole.

5. The hinge device according to claim 1, wherein the first locking portion is a concave portion.

6. The hinge device according to claim 1, wherein the second locking portion is a convex portion.

7. The hinge device according to claim 6, wherein the second locking portion is a strip-like projection.

8. The hinge device according to claim 1, further comprising a fixing member for fixing the connecting shaft.

9. The hinge device according to claim 8, wherein one end of the connecting shaft has a plurality of threads, and the fixing member is a nut.

10. The hinge device according to claim 8, further comprising a washer disposed between the first through hole and the fixing member.

11. The hinge device according to claim 1, wherein the first locking element is connected with the first connecting element by way of locking.

12. The hinge device according to claim 1, wherein the first locking element is connected with the first connecting element by way of screwing.

13. The hinge device according to claim 1, further comprising a buffer element disposed between the shaft hole of the second locking element and the connecting shaft.

14. A hinge device with a locking function, comprising:
a first locking element having a slot; and
a second locking element having a cylinder, a side surface of the cylinder having a strip-like projection for locking with the slot, wherein the strip-like projection parts from the slot when the second locking element is rotated.

15. The hinge device according to claim 14, wherein the first locking element further has a first through hole and the second locking element further has a shaft hole.

16. The hinge device according to claim 15, further comprising:
a connecting shaft passing through the first through hole and the shaft hole such that the second locking element is pivotally rotatable.

17. The hinge device according to claim 16, further comprising a fixing member for fixing the connecting shaft.

18. The hinge device according to claim 17, wherein one end of the connecting shaft has a plurality of threads and the fixing member is a nut.

19. The hinge device according to claim 17, further comprising a washer disposed between the first through hole and the fixing member.
